(19) United States
(12) Patent Application Publication
(10) Pub. No.: US 2021/0387290 A1
(43) Pub. Date: Dec. 16, 2021

(54) PROCESS FOR FORMING AN ELECTRIC HEATER

(71) Applicant: Heraeus Precious Metals North America Conshohocken LLC, West Conshohocken, PA (US)

(72) Inventors: Ryan Persons, Newtown Square, PA (US); Sebastian Fritzsche, Hessen (DE); Steffan Kass, Hessen (DE); Tanja Dickel, Hessen (DE)

(21) Appl. No.: 17/309,323

(22) PCT Filed: Dec. 3, 2019
(86) PCT No.: PCT/US2019/064288

§ 371 Date: May 19, 2021

Related U.S. Application Data
(60) Provisional application No. 62/780,541, filed on Dec. 17, 2018.

(51) Int. Cl. B23K 35/26; B23K 35/02; B23K 35/362; C22C 13/00

(52) U.S. Cl. CPC B23K 35/262; C22C 13/00; B23K 35/362; B23K 35/025

(57) ABSTRACT

Processes for forming an electric heater comprise providing a heater element and a power supply, applying a layer of a diffusion solder paste onto the heater element and/or the power supply and drying the applied diffusion solder paste, arranging the heater element and the power supply such that the heater element and the power supply contact each other via the dried diffusion solder paste, and diffusion soldering the arrangement to form a connection between the heater element and the power supply. The diffusion solder paste comprises or consists of 10-30 wt.-% of at least one type of particles selected from the group consisting of copper particles, copper-rich copper/zinc alloy particles, and copper-rich copper/tin alloy particles, 60-80 wt.-% of at least one type of particles selected from tin particles, tin-rich tin/copper alloy particles, tin-rich tin/silver alloy particles, and tin-rich tin/copper/silver alloy particles, and 3-30 wt.-% of a solder flux.

### CROSS REFERENCE TO RELATED APPLICATION

This application claims the benefit of U.S. Provisional Application No. 62/780,541 filed Dec. 17, 2018, the entire contents of which are incorporated herein by reference.

### FIELD OF THE INVENTION

The invention relates to a process for forming (process for making, process for the manufacture of) an electric heater, in particular, to a process for forming an electric heater comprising a heater element and a power supply connected to each other by a diffusion solder.

### BACKGROUND OF THE INVENTION

WO 2011/009597 A1 discloses the joining of an electronic component to a substrate by diffusion soldering. The diffusion solder material is provided in the form of a diffusion solder paste. The diffusion solder paste comprises (i) 10-30 wt.-% (weight-%, % by weight) of copper particles, (ii) 60-80 wt.-% of tin and/or tin-copper alloy particles, and (iii) 3 to 30 wt.-% of flux.

### BRIEF DESCRIPTION OF THE DRAWINGS

FIG. 1 is a schematic illustration of a substrate of an electric heater with conductive pads and a conductive strip formed thereon.

FIG. 2 is a schematic illustration of the substrate of FIG. 1 with resistors formed thereon.

FIG. 3 is a schematic illustration of the substrate of FIG. 2 with an overglaze formed on portions thereof, leaving portions of the conductive pads exposed.

FIG. 4 is a schematic illustration of the substrate of FIG. 3 with a diffusion solder paste applied on the exposed portions of the conductive pads.

FIG. 5 is a schematic illustration of an electric heater with lead wires electrically coupled therewith.

### DETAILED DESCRIPTION

State of the art electric heaters comprise a heater element which is electrically connected to a power supply, typically by a tin- or lead-based solder connection. Especially in the case of electric heaters having a heater element operating in an elevated temperature range of, for example, 200-250° C., such solder connection is typically a lead-based solder. Lead is a hazardous material and needs to be replaced by a less problematic material. A previous alternative to the use of lead-based solder was to make said electrical connection from a silver high temperature brazing material. However, the applicant has now found a process which offers an effective alternative to silver high temperature brazing for electrically connecting a heater element to a power supply of an electric heater, in particular, even in case of electric heaters with a heater element having an operational temperature (i.e. the operational temperature of the heater element itself) in and appreciably above said elevated temperature range.

The invention relates to a process for forming an electric heater comprising the steps:

(a) providing a heater element and a power supply,

(b) applying a layer of a diffusion solder paste onto the heater element and/or the power supply and drying the applied diffusion solder paste,

(c) appropriately arranging the heater element and the power supply such that the heater element and the power supply contact each other by means of the dried diffusion solder paste, and

(d) diffusion soldering the arrangement produced in step (c) to form a connection between the heater element and the power supply,

wherein the diffusion solder paste comprises or consists of (i) 10-30 wt.-% of at least one type of particles selected from the group consisting of copper particles, copper-rich copper/zinc alloy particles, and copper-rich copper/tin alloy particles, (ii) 60-80 wt.-% of at least one type of particles selected from the group consisting of tin particles, tin-rich tin/copper alloy particles, tin-rich tin/silver alloy particles, and tin-rich tin/copper/silver alloy particles, and (iii) 3-30 wt.-% of a solder flux.

The term “electric heater” used herein means a heating device (a device for the supply of heat) comprising a heater element connected to a power supply. The heater element converts electrical energy into heat. Typically, an electric heater is a heating device as part of a more complex device or apparatus. Examples of such more complex devices include so-called brown goods like, for example, pressing irons, electric kettles, coffee makers, steamers and hot plates; so-called white goods like, for example, clothes dryers, washing machines and dishwashers; lifestyle goods like, for example, e-cigarettes, hair straighteners and hair dryers; automotive applications like, for example, automotive seat heaters and window/mirror defrosters.

The heater element is the technical component of the electric heater that converts electrical energy into heat by way of resistive or Joule heating. The heater element can be made of a variety of different materials. It can comprise only one material or more than one material. Examples of such materials include conductor materials (e.g. silver, copper, platinum, palladium or any combination or alloy thereof) and resistor materials (e.g. ruthenium oxide, ruthenium oxide/silver, ruthenium oxide/palladium, nickel-chrome-alloys, tungsten, molybdenum).

The heater element is neither a semiconductor, nor is it another electronic component like those typically used in electronics or microelectronics. It is also not a substrate; in particular, it is not a substrate like those typically used in electronics or microelectronics; hence, it is in particular neither a leadframe nor is it a printed circuit board, a ceramic substrate, a metal-ceramic substrate (like a DCB or the like) or an insulated metal substrate.

The heater element can comprise a connection part and a heat generating part. The connection part of the heater element is the part of the heater element that is to be connected to the power supply.

In a first embodiment, the heat generating part can be in direct physical and electrical connection to the connection part of the heater element.

In a second embodiment, the heat generating part and the connection part of the heater element can be designed as a one-piece heater element.

The layout (i.e. shape and size) of the heat generating part of the heater element is determined by type, design and function of the electric heater. In an embodiment, the connection part and the heat generating part of the heater element can be made of one and the same material or of one and the same material combination (e.g. the entire heater element may be made of silver or of silver/platinum). In another embodiment, the connection part and the heat generating part of the heater element can be made of different materials or of different material combinations (e.g. the connection part may be made of silver or silver/platinum and the heat generating part may be made of ruthenium oxide/silver).

The heater element can comprise a material or a material combination that may be formed from a conductor paste and/or from a resistor paste, i.e. the heater element can be produced by applying and drying a conductor paste and/or a resistor paste, and finally heating the dried conductor paste and/or resistor paste to an elevated temperature in order to form the heater element. Preferably, the heater element consists of such type of material or material combination.

Examples of conductor pastes include C 4727, available from Heraeus Deutschland GmbH & Co. KG, Germany. Examples of resistor pastes include R 2200 Series, available from Heraeus Deutschland GmbH & Co. KG, Germany.

The term “power supply” used herein means an electrical connection by which an external electrical power can be applied to the heater element of the electric heater or, to be more precise, to the connection part of the heater element of the electric heater. Examples of power supplies include surface mountable components (for example, quick connects, resistance temperature detectors (RTDs), inductors and/or capacitors) and, in particular, lead wires of various materials. Examples of such lead wires include silver wires, copper wires, aluminum wires, steel wires and platinum wires.

In step (b) of the process of the invention a layer of a diffusion solder paste is applied onto the heater element and/or onto the power supply and then dried. In other words, the diffusion solder paste is applied onto a contact surface of the connection part of the heater element and/or onto a contact surface of the power supply. In an embodiment, the power supply and/or the heater element may be coated with a metallization layer at their contact surface, i.e. the surface that comes into contact with the diffusion solder paste.

Application of the diffusion solder paste can be effected through any conventional method known to the skilled person, for example, by screen printing, stencil printing, jetting or dispensing.

The diffusion solder paste comprises (i) 10-30 wt.-%, preferably 12-28 wt.-%, and more preferably 15-25 wt.-% of at least one type of particles selected from the group consisting of copper particles, copper-rich copper/zinc alloy particles, and copper-rich copper/tin alloy particles, (ii) 60-80 wt.-%, preferably 62-78 wt.-%, and more preferably 65-75 wt.-% of at least one type of particles selected from the group consisting of tin particles, tin-rich tin/copper alloy particles, tin-rich tin/silver alloy particles, and tin-rich tin/copper/silver alloy particles, and (iii) 3-30 wt.-%, preferably 5-20 wt.-%, and more preferably 6-15 wt.-% of a solder flux.

Preferably, the diffusion solder paste consists of (i) 10-30 wt.-%, preferably 12-28 wt.-%, and more preferably 15-25 wt.-% of at least one type of particles selected from the group consisting of copper particles, copper-rich copper/zinc alloy particles, and copper-rich copper/tin alloy particles, (ii) 60-80 wt.-%, preferably 62-78 wt.-%, and more preferably 65-75 wt.-% of at least one type of particles selected from the group consisting of tin particles, tin-rich tin/copper alloy particles, tin-rich tin/silver alloy particles, and tin-rich tin/copper/silver alloy particles, and (iii) 3-30 wt.-%, preferably 5-20 wt.-%, and more preferably 6-15 wt.-% of a solder flux.

The purity of the copper of the copper particles (i) contained in the diffusion solder paste preferably is at least 99.9 wt.-% (3 N) and more preferably at least 99.99 wt.-% (4 N). In the case of particles (i) made of copper-rich copper/zinc alloys and/or copper-rich copper/tin alloys, the composition is 60-99.5 wt.-% copper and, correspondingly, 0.5-40 wt.-% zinc or tin. Preferably, the particles (i) are particles produced by atomization of a copper or copper alloy melt in an inert gas atmosphere or, in other words, particles produced by atomization of liquid copper or copper alloy into an inert gas atmosphere.

As mentioned above, the diffusion solder paste comprises at least one type of solder metal particles (ii) selected from the group consisting of tin particles, tin-rich tin/copper alloy particles, tin-rich tin/silver alloy particles, and tin-rich tin/copper/silver alloy particles.

If the diffusion solder paste comprises tin-rich tin/copper, tin/silver and/or tin/copper/silver alloy particles, it is preferred that the tin fraction thereof is in the range of 95-99.5 wt.-% and the copper and/or silver fraction is in the range of 0.5-5 wt.-%.

The mean particle diameter of particles (i) can be, for example, ≤30 μm, preferably ≤20 μm, more preferably ≤15 μm, and even more preferably ≤10 μm. Preferably, the mean particle diameter can be in the range of 1-30 μm, more preferably in the range of 1-20 μm, even more preferably in the range of 1-15 μm, and yet even more preferably in the range of 1-10 μm.

The mean particle diameter of particles (ii) can be, for example, ≤80 μm, preferably ≤50 μm, more preferably ≤30 μm, and even more preferably ≤20 μm. Preferably, the mean particle diameter can be in the range of 1-80 μm, more preferably in the range of 1-50 μm, even more preferably in the range of 1-30 μm, and yet even more preferably in the range of 1-20 μm.

The term “mean particle diameter” used herein means the mean particle size (d50) that can be determined with an optical microscope. Measurements of this type can be made with an optical microscope, for example at 200-fold magnification, in combination with a common digital image processing system (CCD digital camera and analytical software), for example with a measuring system from Microvision Instruments. For example, a mean particle diameter of ≤15 μm can mean that at least 90% of the particles have a particle diameter ≤15 μm and less than 10% of the particles have a particle diameter of more than 15 μm. Accordingly, a mean particle diameter being in the range of 2-15 μm means that at least 90% of the particles have a particle diameter in the range of 2-15 μm and less than 10% of the particles have a particle diameter of less than 2 μm or more than 15 μm.

The particles (i) and (ii) can have different shapes. However, it is preferred that particles (i) and (ii) have a spherical shape. It is preferred that at least 90 wt.-%, more preferably at least 95 wt.-%, even more preferably at least 99 wt.-% or 100 wt.-% of particles (i) and (ii) have a spherical shape.

The solder flux present in the diffusion solder paste serves to reduce (de-oxidize) the contact surface of the heater element and/or the power supply during the diffusion soldering process, to prevent renewed oxide formation before and after the diffusion soldering process, and to reduce the inclusion of foreign substances. Moreover, the solder flux can reduce the surface tension of the liquid diffusion solder. For example, colophony, colophony-based resin systems, water-based resin systems or systems based on carboxylic acids (e.g. carboxylic acids such as citric acid, adipic acid, cinnamic acid, and benzilic acid), amines (e.g. tertiary amines), and solvents (e.g. polar solvents like water and/or a polyol such as glycol or glycerol) can be used as solder flux.

The diffusion solder paste may comprise further ingredients such as, for example, alcohols, fatty acids (e.g. saturated fatty acids, such as oleic acid, myristic acid, palmitic acid, margaric acid, stearic acid or eicosanoic acid), polysiloxane compounds or phosphide compounds.

The diffusion solder paste comprises preferably no lead, i.e. it is preferably lead-free. Being lead-free shall mean that the diffusion solder paste comprises no lead except for optionally present contaminating lead that may be present due to technical reasons. Accordingly, lead-free shall be understood to mean a lead content of less than 1 wt.-%, preferably of less than 0.5 wt.-%, more preferably of less than 0.1 wt.-%, even more preferably of less than 0.01 wt.-% and, in particular of 0 wt.-%, based on the weight of the diffusion solder paste.

The diffusion solder paste is applied at a wet layer thickness of, for example, 20-500 μm, preferably 20-300 μm, and then dried for, for example, 10-60 minutes at an object temperature of, for example, 50-160° C.

After conclusion of step (b), i.e. in step (c), the heater element and the power supply are arranged appropriately such that the connection part of the heater element and the power supply contact each other by means of the dried diffusion solder paste.

After conclusion of step (c) the so-produced arrangement made up of power supply, heater element and dried diffusion solder paste in between is diffusion soldered in step (d) to form a mechanical and electrical connection between the connection part of the heater element and the power supply. To this end, said arrangement is heated, preferably evenly until the actual diffusion soldering temperature is reached. According to a preferred embodiment, the heating proceeds at a rate of ≤3° C. per second. Preferably, the diffusion soldering temperature is 10-50° C., more preferably 15-45° C., and even more preferably 25-35° C., for example, 30° C. above the melting temperature of the diffusion solder employed or, to be more precise, of the solder particles (ii) thereof. According to another preferred embodiment, the diffusion soldering temperature is below 280° C., for example, in the range of 240-260° C. The diffusion soldering temperature is kept above the diffusion solder's liquidus temperature (melting temperature of the diffusion solder), for example, for a period of at least 15 seconds, preferably of at least 20 seconds, and even more preferably of at least 30 seconds.

After conclusion of step (d) it may be advantageous to subject the diffusion soldered arrangement (i.e. the electric heater) to a heat treatment. Heat treatment means treating the diffusion soldered arrangement with heat below the liquidus temperature of the diffusion solder. The heat treatment preferably proceeds at a temperature above 40° C., for example in the range of 40-275° C., more preferably in the range of 100-250° C., and even more preferably in the range of 150-225° C. The heat treatment preferably proceeds for a duration of 1 minute to 24 hours, more preferably for 10 minutes to 10 hours, and even more preferably for 20 minutes to 1 hour. The duration of the heat treatment is usually correlated with the temperature and is the longer, the lower the heat treatment temperature.

The electric heater as product obtained by the process of the invention comprises the heater element and the power supply connected via their contact surfaces by a layer of diffusion solder in between having a layer thickness (i.e. after diffusion soldering) in the range of, for example, 20 to 500 μm.

It is advantageous, that the arrangement formed after conclusion of step (d) or after said optional heat treatment, i.e. the electric heater so formed, can be used at an operational temperature in the range of 50-500° C., preferably in the range of 100-400° C., more preferably in the range of 120-350° C. and most preferably in the range of 150-325° C. The operational temperature may be constant or it may vary up and down within said operational temperature range during heat supply operation. It is also advantageous that the electric heater withstands a huge number of on/off cycles without showing signs of material fatigue, provided the upper limit of the operational temperature range is not exceeded.

Hence, the invention relates also to an electric heater formed by the process of the invention. The invention relates furthermore also to the use of the electric heater for supplying heat at an operational temperature in the range of 50-500° C., preferably in the range of 100-400° C., more preferably in the range of 120-350° C. and most preferably in the range of 150-325° C.; in other words, the invention relates also to a process for the supply of heat making use of the electric heater at an operational temperature in the range of 50-500° C., preferably in the range of 100-400° C., more preferably in the range of 120-350° C. and most preferably in the range of 150-325° C.

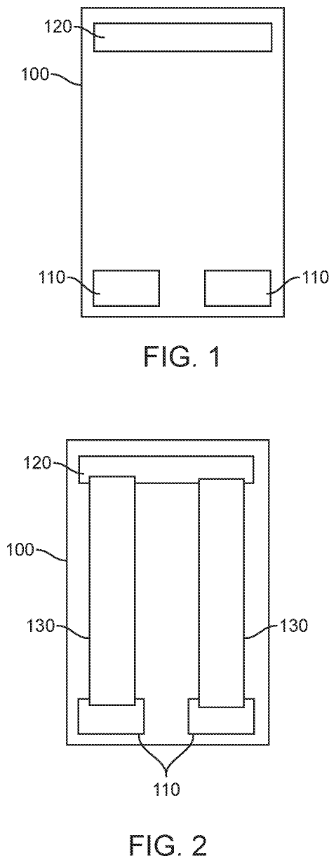

In view of the above, a general exemplary process for fabricating an electric heater is provided with reference to FIGS. 1-5. First, as shown in FIG. 1, an electric heater substrate 100 having conductive pads 110 is provided. The composition of the electric heater substrate 100 can be any suitable composition and will likely be chosen based on end-use operating parameters of the electric heater. In some instances, the substrate 100 can be made of, for example, a ceramic. In other instances, the substrate 100 can be made of, for example, a metal or metal alloy having a dielectric isolation material applied thereon. In yet other instances, the substrate 100 can be made of, for example, a polymeric material such as a polyimide. In FIG. 1, the electric heater substrate 100 includes two conductive pads 110 and a conductive strip 120. In some instances, an electric heater substrate 100 having more than two conductive pads 110 such as, for example, four conductive pads 110, may be used. The conductive pads 110 can be formed from a conductive paste that is applied onto the substrate 100 (by, for example, stencil printing), dried and subsequently fired or cured. The conductive pads 110 can be made of any suitable material including, but not limited to, Ag, Ag/Pt, Ag/Pd, and Pt. The conductive strip 120 can be made of the same or substantially the same material(s) as the conductive pads 110 and formed on the substrate using the same or substantially the same procedure. While the shapes of the electric heater substrate 100, the conductive pads 110 and the conductive strip 120 in FIG. 1 are shown as rectangular in shape, such elements are not limited in terms of shape or their relative dimensions.

Next, in FIG. 2, each conductive pad 110 is electrically connected with the conductive strip 120 by a corresponding resistor 130. Like the conductive pads 110 and conductive strip 120, each resistor 130 can be formed from a paste that is applied onto the substrate 100, conductive pad 110 and conductive strip 120 (by, for example, stencil printing), dried and subsequently fired or cured. Like the substrate 100, the conductive pads 110, and the conductive strip 120, the resistors 130 are not limited in terms of shape or their relative dimensions.

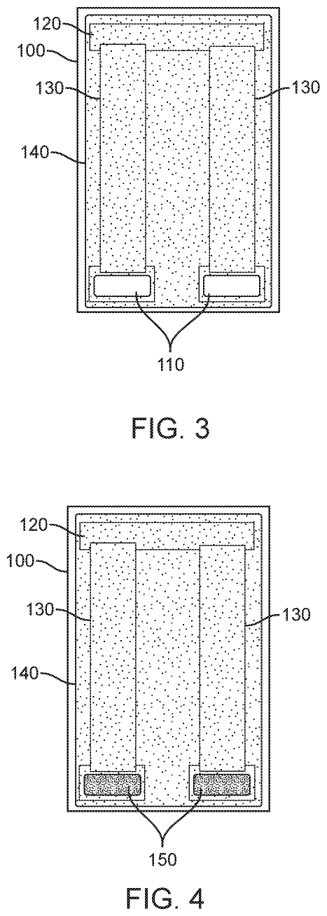

Then, in FIG. 3, an overglaze 140 is applied over the conductive strip 120, resistors 130, a portion of the substrate 100 and portions of the conductive pads 110, leaving exposed portions of the conductive pads 110 uncovered by the overglaze 140.

Next, in FIG. 4, a diffusion solder paste 150 in accordance with various aspects of the disclosure is applied (by, for example, stencil printing) onto the exposed portions of the conductive pads 110.

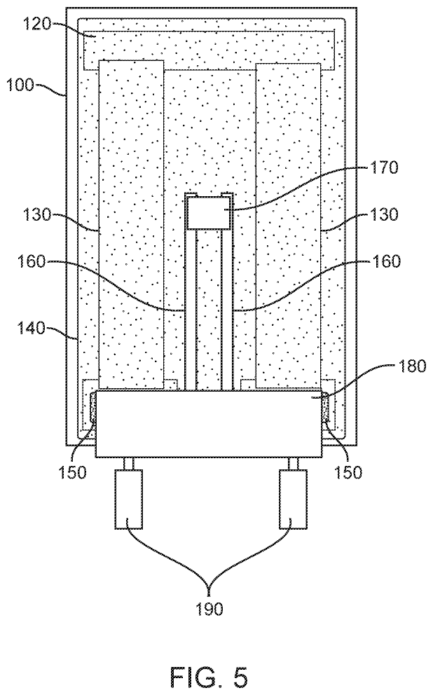

Then, in FIG. 5, electrical connections 160 and a quick connector 180 are placed on the diffusion solder paste 150 and a resistance temperature detector (RTD) 170 is placed on each of the electrical connections 160. This assembly is then subjected to drying and soldering processes to yield the final electric heater. After formation of the final electric heater, lead wires 190 (one cathodic and one anodic) can be electrically coupled with the electric heater via the quick connector 180.

In some instances, the quick connector 180 can be omitted and the lead wires 190 can instead be directly applied to the diffusion solder paste 150 prior to subjecting to drying and soldering processes to yield the final electric heater.

### EXAMPLES

### Example 1

Preparation of a diffusion solder paste. In a mixing vessel, copper particles (10-45 micrometer particle sizes), SAC 305 (lead-free solder alloy, 96.5% Sn, 3% Ag, 0.5% Cu, AIM Metals & Alloys LP) and solder flux are added and mixed to form a homogenous paste. The solder flux is made of 83.5 wt % terpineol, 10 wt % Exxol™ D120 (CAS #64742-47-8, petroleum distillates, hydrotreated light; hydrocarbons, C14-C18, n-alkanes, iso-alkanes, cyclics, <2% aromatics; Exxon Mobil) and 6.5 wt % ethylcellulose N100. The final solder paste is 27 wt % copper particles, 63 wt % SAC 305 and 10 wt % solder flux.

### Example 2

Preparation of a diffusion solder paste. In a mixing vessel, copper particles (10-45 micrometer particle sizes), SnCu_{0.7} particles (5-45 micrometer particle sizes) and solder flux are added and mixed to form a homogenous paste. The solder flux is made of 83.5 wt % terpineol, 10 wt % Exxol™ D120 (CAS #64742-47-8, petroleum distillates, hydrotreated light; hydrocarbons, C14-C18, n-alkanes, iso-alkanes, cyclics, <2% aromatics; Exxon Mobil) and 6.5 wt % ethylcellulose N100. The final solder paste is 27 wt % copper particles, 63 wt % SnCu_{0.7} particles and 10 wt % solder flux.

### Example 3

Preparation of an electric heater. An electric heater substrate having a fired conductive strip, conductive pads, resistors and overglaze (see, for example, FIGS. 1-3) is placed into a stencil printer. The stencil printer has openings for the application of a diffusion solder paste (for example, a paste prepared according to Example 1 or 2) onto conductive pads on the heater substrate which are not coated with the overglaze. In this case, the heater substrate has two conductive pads. The diffusion solder paste is coated onto the conductive pads using the stencil printer to form a solder paste thick film on each conductive pad. A portion of an electrical connection for a resistance temperature detector (RTD) is placed on each of the solder paste thick films. The portion of the electrical connection disposed on a corresponding solder paste thick film will only cover a portion of the corresponding solder paste thick film. An RTD is then electrically coupled with each of the two electrical connections. A quick connector, for subsequent electrical coupling of lead wires to the final electric heater, is then placed on each of the solder paste thick films. The resulting assembly is then subjected to pre-drying the assembly in a box oven at 150° C. for 10 minutes under a nitrogen (N₂(g)) atmosphere. After pre-drying, the assembly is transferred to a Pink VADU200 reflow oven and soldering is commenced with formic acid using a six-step soldering profile as follows. First, the reflow oven is heated from 25 to 200° C. over a 10 minute period of time with a formic acid pressure of 580 millibar (mbar). Second, a pre-conditioning step is performed at 200° C. for 10 minutes with a formic acid pressure of 790 mbar. Third, the reflow oven is heated from 200 to 250° C. over a 3 minute period of time with a formic acid pressure of 790 millibar (mbar). Fourth, the reflow oven is maintained at 250° C. for 3 minutes with a formic acid pressure of 150 mbar. Fifth, the assembly is subjected to vacuum drawing and N₂(g) purging within the reflow dryer. Sixth, the reflow oven is cooled from 250 to 25° C. over a 3 minute period of time under an N₂(g) atmosphere.

While the above example uses a particular six-step soldering profile, one or more of the steps may be modified, or one or more steps may be added or removed, based on the materials used to fabricate the electric heater.

After the final electric heater is formed, leads wires can be coupled with the electric heater via the quick connector. The solder joints of the final electric heater exhibit a secondary reflow temperature in excess of 350° C., allowing for operation at temperatures up to 325° C. without any degradation of the solder joints.

1. A process for forming an electric heater comprising the steps:
(a) providing a heater element and a power supply,
(b) applying a layer of a diffusion solder paste onto the heater element and/or the power supply and drying the applied diffusion solder paste,
(c) appropriately arranging the heater element and the power supply such that the heater element and the power supply contact each other by means of the dried diffusion solder paste, and
(d) diffusion soldering the arrangement produced in step (c) to form a connection between the heater element and the power supply,
wherein the diffusion solder paste comprises (i) 10-30 wt.-% of at least one type of particles selected from the group consisting of copper particles, copper-rich copper/zinc alloy particles, and copper-rich copper/tin alloy particles, (ii) 60-80 wt.-% of at least one type of particles selected from the group consisting of tin particles, tin-rich tin/copper alloy particles, tin-rich tin/silver alloy particles, and tin-rich tin/copper/silver alloy particles, and (iii) 3-30 wt.-% of a solder flux.

2. The process of claim 1, wherein the electric heater forms a heating device as part of a more complex device.

3. The process of claim 2, wherein the more complex device is selected among brown goods, white goods, lifestyle goods and automotive applications.

4. The process of claim 1, wherein the diffusion solder paste is applied by screen printing, stencil printing, jetting or dispensing.

5. The process of claim 1, wherein the particles (i) are particles produced by atomization of a copper or copper alloy melt in an inert gas atmosphere.

6. The process of claim 1, wherein the particles (i) and (ii) have a spherical shape.

7. The process of claim 1, wherein the diffusion solder paste is lead-free.

8. The process of claim 1, wherein the diffusion solder paste is applied at a wet layer thickness of 20-500 μm and then dried for 10-60 minutes at an object temperature of 50-160° C.

9. An electric heater formed by a process of claim 1.

10. A process for the supply of heat, wherein an electric heater formed by a process of claim 1 is used at an operational temperature in the range of 50-500° C.

11. The process of claim 1, wherein the diffusion solder paste consists of (i) 10-30 wt.-% of the at least one type of particles selected from the group consisting of copper particles, copper-rich copper/zinc alloy particles, and copper-rich copper/tin alloy particles, (ii) 60-80 wt.-% of the at least one type of particles selected from the group consisting of tin particles, tin-rich tin/copper alloy particles, tin-rich tin/silver alloy particles, and tin-rich tin/copper/silver alloy particles, and (iii) 3-30 wt.-% of the solder flux.

12. The process of claim 1, wherein the particles (i) have a mean particle diameter of 1 to 30 μm.

13. The process of claim 1, wherein the particles (ii) have a mean particle diameter of 1 to 80 μm.

14. The process of claim 1, wherein
the particles (ii) are selected from the group consisting of tin-rich tin/copper alloy particles, tin-rich tin/silver alloy particles, and tin-rich tin/copper/silver alloy particles;
the tin fraction of the particles (ii) is in the range of 95-99.5 wt.-%; and
the copper and/or silver fraction of the particles (ii) is in the range of 0.5-5 wt.-%.

15. The process of claim 1, wherein at least 90 wt.-% of the particles (i) and (ii) have a spherical shape.

16. The process of claim 1, wherein the particles (i) are copper particles having a purity of at least 99.9 wt.-%.

17. The process of claim 1, wherein the particles (i) are copper-rich copper/zinc alloy particles or copper-rich copper/tin alloy particles and the particles (i) have 60-99.5 wt.-% copper.
